(19) United States
(12) Patent Application Publication
(10) Pub. No.: US 2013/0064308 A1
(43) Pub. Date: Mar. 14, 2013

(54) CODING AND DECODING SYNCHRONIZED COMPRESSED VIDEO BITSTREAMS

(71) Applicants: Robert S. Nemiroff, Carlsbad, CA (US); Jing Yang Chen, San Diego, CA (US); Rebecca Lam, San Diego, CA (US); Brenda L. Van Veldhuisen, Portland, OR (US); Siu-Wai Wu, San Diego, CA (US)

(72) Inventors: Robert S. Nemiroff, Carlsbad, CA (US); Jing Yang Chen, San Diego, CA (US); Rebecca Lam, San Diego, CA (US); Brenda L. Van Veldhuisen, Portland, OR (US); Siu-Wai Wu, San Diego, CA (US)

(73) Assignee: GENERAL INSTRUMENT CORPORATION, Horsham, PA (US)

(21) Appl. No.: 13/232,557

(22) Filed: Sep. 14, 2011

(51) Int. Cl. H04N 7/54

(52) U.S. Cl. 375/240.28; 375/E07.27

(57) ABSTRACT

Coding may include receiving a source video bitstream including source frames and determining information from the source frames. The determined information may include timing information and grouping information and may be utilized in encoding synchronizing processed frames for a synchronized compressed video bitstream. Decoding may include receiving a synchronized compressed video bitstream including the encoding synchronizing processed frames. The decoding may include preparing video chunk files having boundaries defined by the encoding synchronizing processed frames and decoding the prepared video chunk files.

### BACKGROUND

Digital content distribution often involves transmitting video content streams or “channels” in multiple formats. Multiple formats are often transmitted to accommodate various types of decoding devices which require different formats. In the case of mobile decoding devices, such as laptops, tablets, cell phones, personal media players, etc., these often operate using different formats because bit rate or data throughput (i.e., the rate of data transfer, also known as “bandwidth”) to these consumer devices is not constant. Another reason is because the video signal to a mobile device may change depending on the physical interface actively utilized and the integrity of the signal which is being received.

Because the bandwidth reaching mobile devices is generally not constant, and because different decoding devices may only support certain video formats, it would not be ideal to send a single digital video signal which supports many devices at a minimum rate. The video quality would be suboptimal. Instead, content distributors attempt to address the different formats and changes to bandwidth by transmitting simultaneous video content streams in different formats and at different bandwidths. At the receiving end, the decoding devices attempt to maintain the best available video quality, at any given time, by processing the received video in the most favorable format received at the highest possible bandwidth which the receiving device can use. Decoding devices often adjust the format and/or bandwidth utilized when circumstances change.

Decoding devices commonly manage the ongoing changes to format and bandwidth by grouping together received video frames which are the same format. These groupings of video frames are called chunks or chunk files. The end frames in a chunk file are called chunk boundaries. Chunk files vary in size and commonly range from 1 to 30 seconds in terms of playing time length. The size of any chunk file is generally a function of the programming set for a decoding device. A video player in the device processes video frames within a chunk and the decoder switches the format of frames in the next chunk, if called for, at a chunk boundary.

While playing a video program, decoding devices switch to the highest format and bandwidth possible. At any switch point, the displayed video should not reveal the switch. But often it is not possible to avoid noticeable errors in the video displayed. The errors include user-perceivable glitches or jitters which are caused by a change in bandwidth or video format. Although a user may notice a change in video quality, the transition should be seamless. Reductions in such glitches and jitters are commonly addressed through synchronizing chunk file boundaries among simultaneous transmissions of video content in different formats/bandwidths.

Coding systems, such as encoders and transcoders, commonly achieve synchronization by signaling chunk boundary information to each other. However, signaling chunk boundary information requires the coding devices be able to communicate with each other. Inter coding device communication may not be possible in some circumstances, especially if the coding devices are in remote locations as often occurs when video content is distributed through the Internet. In these circumstances, glitches and jitters due to a lack of synchronization among coding systems may degrade a user's experience with their mobile decoding device.

### BRIEF DESCRIPTION OF THE DRAWINGS

Features of the examples and disclosure are apparent to those skilled in the art from the following description with reference to the figures, in which:

FIG. 1 is a block diagram illustrating a system for coding a synchronized compressed video bitstream (SCVB), according to an example;

FIG. 2 is a block diagram illustrating a system for decoding a SCVB, according to an example;

FIG. 3 is a process flow diagram illustrating a method for decoding multiple different SCVBs transmitted simultaneously from multiple systems for coding an SCVB, according to an example;

FIG. 4 is a flow diagram illustrating a method for coding a SCVB, according to an example;

FIG. 5 is a flow diagram illustrating a method for decoding a SCVB, according to an example; and

FIG. 6 is a block diagram illustrating a computer system to provide a platform for a system for coding and/or a system for decoding a SCVB, according to examples.

### SUMMARY

According to principles of the invention, there are systems, methods, and computer readable mediums (CRMs) which provide for coding and decoding SCVBs. These achieve synchronization among various coding sources utilizing the SCVBs and without signaling chunk boundary information among the various coding sources as the sources associated with the systems, methods, and CRMs do not need to communicate with each other. The synchronization reduces the glitches and jitters which may otherwise occur in a displayed video which is viewed at a receiving device. The systems, methods and CRMs therefore enhance a user's experience with their mobile decoding device without a need for communicating synchronization information among sources, which may be expensive, unreliable and otherwise not possible.

According to a first principle of the invention, there is a system for coding. The system may include an interface configured to receive a source video bitstream, including source frames. The system may also include a processor configured to determine timing information and/or grouping information, based on the received source frames. The processor may also be configured to prepare processed frames, including synchronizing processed (SP) frames, based on the received source frames. The SP frames may be prepared based on at least one of the determined timing information and/or the determined grouping information. The processor may also be configured to encode the processed frames, including the SP frames, in a SCVB.

According to a second principle of the invention, there is a method for coding. The method may include receiving a source video bitstream, including source frames. The method may also include determining, utilizing a processor, at least one of timing information and grouping information, based on the received source frames. The method may also include preparing processed frames, including SP frames, based on the received source frames. The SP frames may be prepared based on or more of the determined timing information and/or the determined grouping information. The method may also include encoding the processed frames, including the SP frames, in a SCVB.

According to a third principle of the invention, there is a non-transitory CRM storing computer readable instructions which, when executed by a computer system, perform a method for coding. The method may include receiving a source video bitstream, including source frames. The method may also include determining, utilizing a processor, at least one of timing information and grouping information, based on the received source frames. The method may also include preparing processed frames, including SP frames, based on the received source frames. The SP frames may be prepared based on or more of the determined timing information and/or the determined grouping information. The method may also include encoding the processed frames, including the SP frames, in a SCVB.

According to a fourth principle of the invention, there is a system for decoding. The system may include an interface configured to receive a SCVB, including encoded processed frames and encoded SP frames. The encoded SP frames in the SCVB may describe video chunk file boundaries of video chunk files of encoded processed frames in the SCVB. The system may also include a processor configured to prepare a video chunk file from the received SCVB utilizing the encoded SP frames to identify the video chunk file boundaries of the video chunk file. The processor may also be configured to decode the encoded processed frames in the prepared video chunk file.

According to a fifth principle of the invention, there is a method for decoding. The method may include receiving a SCVB, including encoded processed frames and encoded SP frames. The encoded SP frames in the SCVB may describe video chunk file boundaries of video chunk files of encoded processed frames in the SCVB. The method may also include preparing a video chunk file from the received SCVB utilizing the encoded SP frames to identify the video chunk file boundaries of the video chunk file. The method may also include decoding, utilizing a processor, the encoded processed frames in the prepared video chunk file.

According to a sixth principle of the invention, there is a non-transitory CRM storing computer readable instructions which, when executed by a computer system, perform a method for decoding. The method may include receiving a SCVB, including encoded processed frames and encoded SP frames. The encoded SP frames in the SCVB may describe video chunk file boundaries of video chunk files of encoded processed frames in the SCVB. The method may also include preparing a video chunk file from the received SCVB utilizing the encoded SP frames to identify the video chunk file boundaries of the video chunk file. The method may also include decoding, utilizing a processor, the encoded processed frames in the prepared video chunk file.

These and other objects are accomplished in accordance with the principles of the invention in providing systems, methods and CRMs which code and decode SCVBs. Further features, their nature and various advantages will be more apparent from the accompanying drawings and the following detailed description of the preferred embodiments.

### DETAILED DESCRIPTION

For simplicity and illustrative purposes, the present invention is described by referring mainly to embodiments, principles and examples thereof. In the following description, numerous specific details are set forth in order to provide a thorough understanding of the examples. It is readily apparent however, that the embodiments may be practiced without limitation to these specific details. In other instances, some methods and structures have not been described in detail so as not to unnecessarily obscure the description. Furthermore, different embodiments are described below. The embodiments may be used or performed together in different combinations. As used herein, the term “includes” means “includes at least” but is not limited to the term “including only”. The term “based on” means based at least in part on.

As demonstrated in the following examples and embodiments, there are systems, methods, and machine readable instructions stored on CRMs for encoding and decoding SCVBs. A SCVB includes processed frames, including SP frames for video sequence(s) in a compressed video bitstream. Processed frames, including SP frames, refers to processed frames and/or processed pictures. Pictures may be equivalent to frames or fields within a frame. The SP frames may be prepared based on timing information and/or grouping information that is determined from source frames of a source video bitstream. The SP frames may be prepared utilizing one or more synchronization processes including time stamp synchronization, intracoded frame synchronization, clock reference synchronization, and video buffering synchronization. The SP frames and other processed frames may then be coded in a SCVB. Further details regarding SCVBs, and how they are prepared and utilized, are provided below.

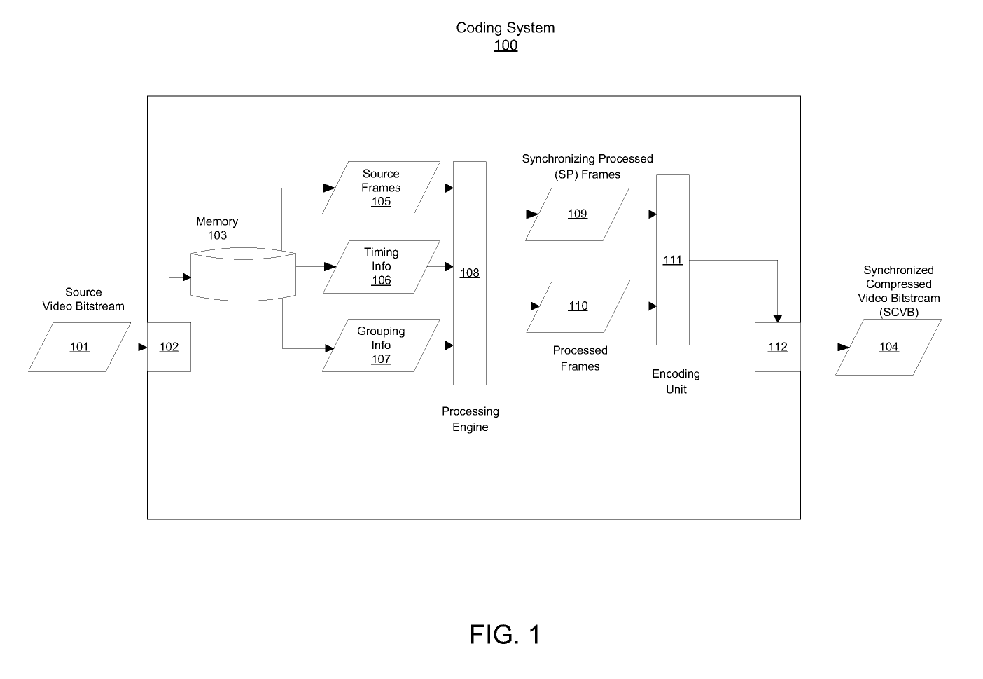

Referring to FIG. 1, there is shown a coding system 100. Coding may include encoding or transcoding and by way of example, the coding system 100 may be found in an apparatus, such as an encoder and/or a transcoder, which is located at a headend for distributing content in a compressed video bitstream, such as a transport stream. According to an example, the coding system 100 receives a source video bitstream, such as source video bitstream 101. The source video bitstream 101 may be compressed or uncompressed and may include source frames, such as source frames 105. Source frames 105 are frames of video, such as frames in video sequences.

The source video bitstream 101 enters the coding system 100 via an interface, such as interface 102 and the source frames may be stored or located in a memory, such as memory 103. A processor may be utilized to determine information from the source frames for subsequent processing in the coding system 100. The determined information may be utilized to develop synchronization points or “markers” which are for chunking purposes at a downstream decoding device which receives the processed source frames in a compressed video bitstream.

The information determined from the source frames 105 may include timing information 106, such as presentation timing stamps read from the headers of the source frames. Another type of information which may be determined from the source frames is grouping information 107. Grouping information 107 relates to information, other than timing information 104, which may also be utilized downstream for chunking purposes. Grouping information 107 may include, for example, an identification of the source frames 105 which occur at scene changes, or an identification of the source frames 105 which occur at repeating regular intervals based on a number of source frames 105 in each interval, or an identification of the source frames 105 which are received as intracoded source frames in the source video bitstream 101.

The source frames 105, the timing information 106 and the grouping information 107 may be signaled to a processing engine 108, such as a processor, a processing module, a firmware, an ASIC, etc. The processing engine 108 may modify the source frames 105 to be processed frames, such as processed frames 110 and SP frames 109. The processed frames 110 may be equivalent to their corresponding source frames 105. In another example, the processed frames 110 may include added referencing, such as to SP frames 109 or some other indicia which indicate that the processed frames 110 are frames in a synchronized video bitstream.

The SP frames 109 are also modified source frames and may be equivalent to the processed frames 110. The modifications may also include one or more changes directed to utilizing the SP frames 109 for chunking purposes. The source frames 105 may be modified so that it marks a chunk boundary which may be utilized downstream in determining video chunk files. This may be done by marking the header of the corresponding source frame, and/or changing a source frame which relies on referencing other frames (i.e., a “P-frame” or “B-frame”) by converting it to an intracoded frame (i.e., an “I-frame”). Another change which may be implemented in preparing an SP frame 109 is by converting a source frame of any picture type to an I-frame which is also encoded to prohibit decoding referencing to frames encoded before the SP frame 109, such as, for example, an independent decoding reference (IDR) frame. The SP frame 109 may also be modified to enhance processes associated with of the chunker and/or the decoder at a downstream decoding device. One way these modifications may enhance downstream processing is by the SP frame 109 providing information it carries downstream, such as presentation time stamps (PTSs), clock references, video buffering verification references and other information. Source frames 105 may be also be deleted or “dropped” to enhance downstream processing at a decoding device.

The SP frames 109 may be prepared utilizing the processing engine 108 based on timing information 106 and/or grouping information 107 determined from the source frames 105. The SP frames 109 may also be prepared through the processing engine 108 implementing one or more processes, including a time stamp synchronization process, an intracoded frame synchronization process, a clock reference synchronization process, and a video buffering synchronization process. The prepared processed frames 110 and the prepared SP frames 109 may be signaled to an encoding unit 111 which encodes them into a SCVB 113 which may be transmitted from the encoding system 100 via an interface 112.

In a time stamp synchronization process of the processing engine 108, PTS information from the source frames 105 may be reproduced, or modified by a traceable adjustment, in the processed frames 110 and/or the synchronized processed frames 109. This information in the processed frames may then be utilized as a basis of synchronizing between encoders/transcoders, such as encoding system 100, encoding a synchronized compressed video by having each encoder/transcoder independently track the PTS of the source frames. Each processed frame 110 and synchronized processed frame 109 contains the same PTS value, or traceable modification, to the source frames 105 from the incoming video bitstream 101. Therefore the PTS will be synchronized among all the transcoded frames such as processed frames 110 and/or the synchronized processed frames 109.

In a first intracoded frame synchronization process of the processing engine 108, intracoded frames (i.e., I-frames) are used as a basis for synchronizing. The I-frame synchronization process may match I-frames with the incoming source video bitstream. So when a frame in the source video bitstream is an I frame, that frame is transcoded as an I frame.

A second intracoded frame synchronization process determines an existing frame as a scene change and marks it, or converts it to an I-frame, or places an I-frame on scene changes where each transcoder has the exact same scene change algorithm. This methodology is also self correcting because if a glitch appears in a source stream due to an upstream error, the I frame placed at the scene change re-synchronize the video at the next scene change.

In a third intracoded frame synchronization process the encoding system 100 may output a constant group of pictures (GOP) length in which there is a fixed number of frames between each SP frame I-frame. In this case, the encoding system 100 may synchronize by detecting when one of the bits in the PTS of the source frames 105 toggles. For example, bit 22 toggles every 46 seconds. When this bit toggles, the encoding system 100 sets the frame at the toggle time to be a SP I-frame. From that point forward every set number of source frames 105 is set to be a synchronized processed frame 109. If this algorithm is implemented uniformly on other encoders/transcoders, then each encoder/transcoder has these I-frames synchronized. If the input is disrupted, the encode/transcoder re-synchronizes the I-frame on the next bit 22 wrap-around.

In a clock reference synchronization process of the processing engine 108, a clock reference from the source frames 105, such as a program clock reference (PCR) value is taken from the source frame header by the processing engine 108 and may be modified and utilized as a basis for synchronization among simultaneous video streams. The modified PCR values applied to the processed frames does not need to match the PCR values from the source frames, but is preferably modified to within a range associated with a tolerance of decoding devices to manage the output from the encoding system 100, such as by indicating a maximum chunk file size. The processing system 100 may synchronize the PCR values applied to the processed frames by detecting when one of the bits in the PTS of the source frames toggles. For example, bit 22 in a PCR may toggle every 46 seconds. When this bit toggles, the encoding system 100 may set the modified PCR of the SP frames 109 to the PTS time of the corresponding source frames plus an offset amount. Other encoding/transcoding systems maintain PCR synchronization with the encoding system 100 as they receive the same PTS values of the source frames thus maintaining a frequency lock utilizing the PCR. If the input video bitstream 101 is disrupted, the encoding system 100 re-synchronizes the PCR on the next bit 22 cycle.

In a video buffering reference synchronization process of the processing engine 108, a video buffer verifier (VBV) reference, such as a VBV value is applied to the processed frames with the maximum VBV value being associated with the SP frames 109. The VBV value signals a decoding device of a tolerance of decoding devices to manage the output from the encoding system 100, such as by indicating a maximum chunk file size.

In some circumstances, the output frame rate of the SCVB 104 is reduced since many mobile devices cannot process high frame rates. In one example, an input stream may be 60 frames per second, and the output stream is reduced to 30 frames per second. As an example, the input stream may be 720p60 and the output from some transcoders is 720p30, and 480p30 from other transcoders. For this circumstance, the transcoders drop ever other frame to achieve the reduced frame rate. Preferably, each transcoder drops the same frames to keep the multiple transcoders frame synchronized.

Dropped frame synchronization may be accomplished in various ways, such as by utilizing the processing engine 108. In an example, the processing engine 108 may synchronize the dropped frames by detecting when one of the bits in the PTS of the source frames 105 toggles. For example, a bit in a frame header may toggle regularly in a compressed bit stream, such as bit 22 (i.e., 0x400000) of the MPEG-2 PES header PTS toggles every 46 seconds. When this bit toggles, the processing engine 108 may drop the source frame 105 at the toggle. From that point forward, every other source frame 105 in one or potential chunk files may be dropped until the toggle reoccurs. At this next toggle, the current frame may be dropped and the process is repeated. When multiple coding systems, such as the coding system 100 process frames this way, the dropped frames are synchronized. If the input to any one of these coding systems is disrupted, the processing engine in the coding system re-synchronizes the drop frame on the next bit 22 cycle.

Dropped frame synchronization may also be accomplished by the processing engine 108 dropping every other frame based on PTS value. For example, when the input is 720p60, the difference between each PTS values of sequential frames may have a cadence, such as cadence: 1501, 1502, 1501, 1502, 1502, 1502, etc. The coding system may monitor the input PTS from the source frames 105 and drop every source frame in which the difference between the PTS of the current frame and previous frame is 1501. When multiple coding systems drop the 1501 PTS difference value source frames, the dropped frame rate is synchronized between the multiple encoding systems. Other difference values, such as the delta 1502 frames may also be used as a basis for dropped frame synchronization.

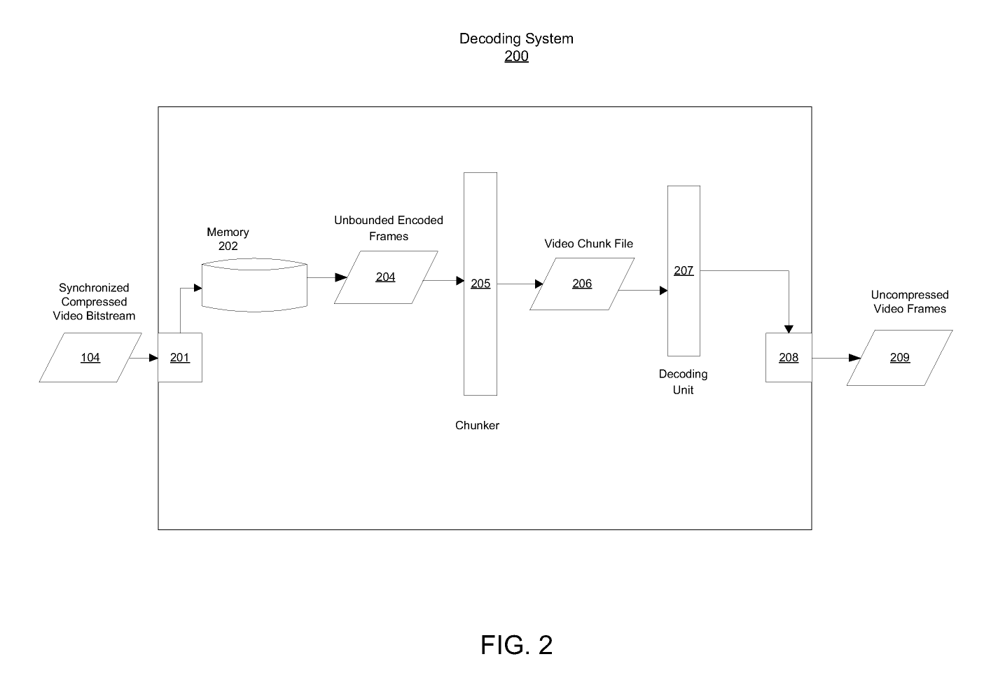

Referring to FIG. 2, there is shown a decoding system 200, as may be found in an apparatus such as a mobile decoding device, a set top box, a transcoder, a handset, a personal computer, etc. for receiving content in a compressed video bitstream, such as the SCVB 104 transmitted from the coding system 100. According to an example, the decoding system 200 receives the SCVB 104 which enters the decoding system 200 via an interface, such as interface 201 and is stored or located in a memory, such as memory 202. A processor may signal encoded frames, such as unbounded encoded frames 204, including encoded processed frames 110 and encoded SP frames 109, to a chunker, such as chunker 205. The chunker 205 may determine chunks, such as video chunk file 206, utilizing the encoded SP frames 109 in the unbounded encoded frames 204 to determine the chunk boundaries of the video chunk file 206. A decoder, such as the decoding module 207, decodes the encoded frames in the video chunk file 206 and signals them from the decoding system 200 as uncompressed video frames 209 via an interface 208.

A principle of the invention is the utilization of multiple SCVBs, all encoded using a common synchronization methodology to prepare SP frames 109 and determine placement of the SP frames 109 in the respective SCVBs 104 for chunking and decoding purposes. By using the common synchronization methodology to prepare the SCVBs 104, the chunk boundaries of the video chunk files 206 taken from respective SCVBs 104 are common chunk boundaries regardless of differences in video format or bandwidth which may be associated with the respective SCVBs 104, because they share common chunk boundaries. Uncompressed video frames 209 decoded from different types of video chunk files 206 may be displayed seamlessly and without perceivable glitches or jitters from mismatched chunk file boundaries assigned at the chunker 206 of the decoding system 200 which receives the different SCVBs.

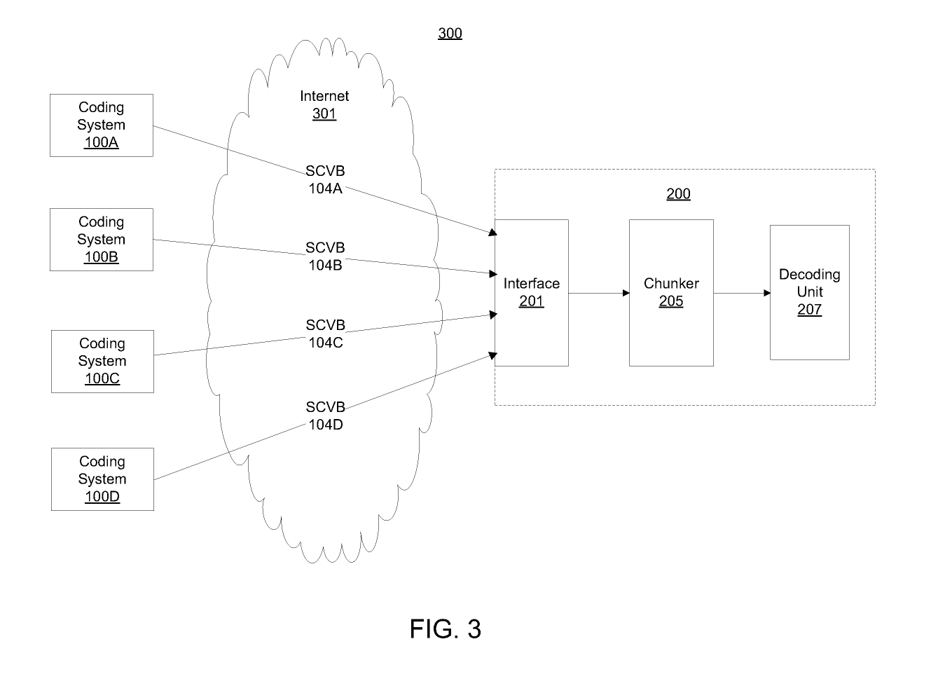

Referring to FIG. 3, coding systems 100A to 100D may be independently operating encoders or transcoders which transmit SCVB 104A to 104D, respectively. The SCVBs 104A to 104D are transmitted via the Internet 301, to interface 201, such as an IP switch for the coding system 200. Encoded frames from all those received at the interface 201 are all signaled to the chunker 205. The chunker 305 builds video chunk files utilizing the SP frames 109. The video chunk files are signaled to the decoding unit 207 for processing and display in a video player.

An input video bitstream to coding units 100A to 100D may be, for example, an MPEG-4 multi-program transport stream (MPTS) or single program transport stream (SPTS) signaled through mediums known in the art. The transmitted SCVBs 104A to 104D may be, for example, multiple SPTS MPEG-4 streams transcoded from a single input program. The SCVBs 104A to 104D may share the same PCR time base, which is synchronized from the input stream. The PTS of the output frames in SCVBs 104A to 104D are synchronized with the corresponding input frame. The picture coding type (I/B/P) of the output frames in the output streams 104A to 104D may be synchronized. At pre-defined splice points using IDR frames as SP frames 109, the chunk boundaries are defined by synchronizing the SP frames 109 in the SCVBs 104A to 104D output streams. The synchronizing in SCVBs 104A to 104D match such that there isn't any decoder buffer overflow/underflow after switching to chunk files from different output streams SCVBs 104A to 104D. The resolutions associated with SCVBs 104A to 104D may vary, and for example, may be different pre-defined bit rates and resolutions such as 1280×720 P/60 fps; 1280×720 P/30 fps (6 Mbps, 3 Mbps); 960×720 P/30 fps; 720×480 P/30 fps (2 Mbps, 1.5 Mbps); 640×480 P/30 fps (1 Mbps, 0.5 Mbps).

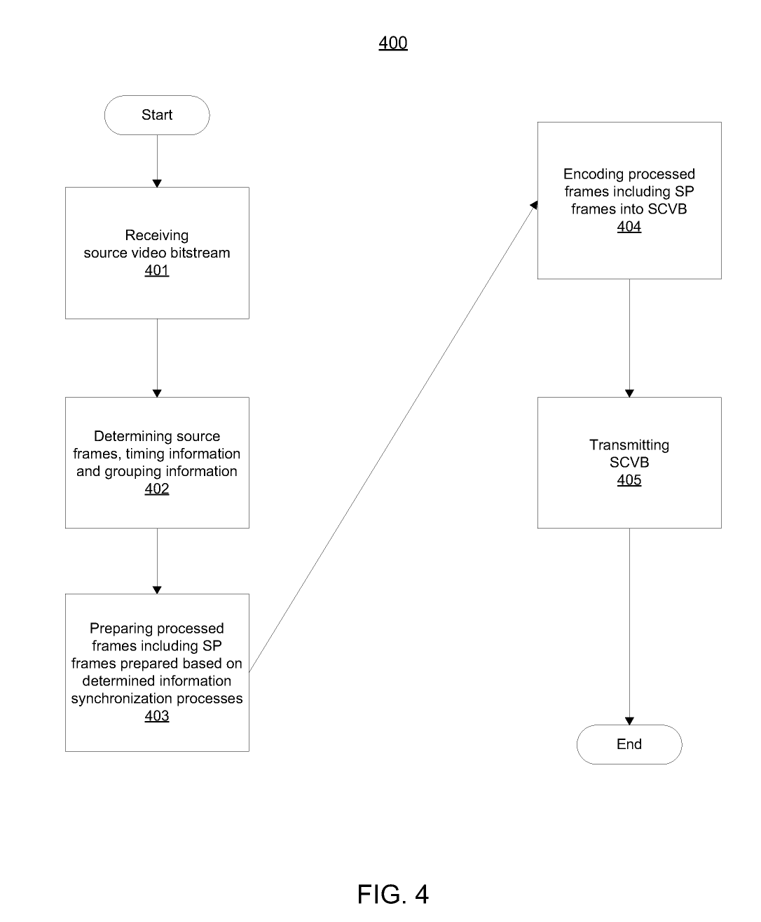

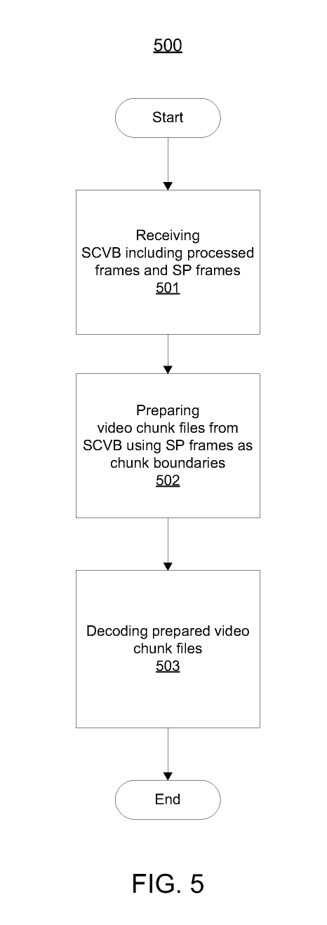

According to an example, the coding systems 100A to 100D may be incorporated or otherwise associated with a transcoder at a headend and the decoding system 200 may be incorporated or otherwise associated with a mobile decoding device such as a handset. These may be utilized separately or together in methods for coding and/or decoding SCVBs, such as SCVB 104 utilizing SP frames 109. Various manners in which the coding system 100 and the decoding system 200 may be implemented are described in greater detail below with respect to FIGS. 4 and 5, which depict flow diagrams of methods 400 and 500.

Method 400 is a method for coding which utilizes SP frames to encode SCVBs. Method 500 is a method for decoding which utilizes SP frames to decode SCVBs. It is apparent to those of ordinary skill in the art that the methods 400 and 500 represent generalized illustrations and that other steps may be added or existing steps may be removed, modified or rearranged without departing from the scopes of the methods 400 and 500. The descriptions of the methods 400 and 500 are made with particular reference to the coding system 100 and the decoding system 200 depicted in FIG. 1 and FIG. 2. It should, however, be understood that the methods 400 and 500 may be implemented in systems and/or devices which differ from the coding system 100 and the decoding system 200 without departing from the scopes of the methods 400 and 500.

With reference to the method 400 in FIG. 4, at step 401, the interface 102 associated with the encoding system 100 receives a source video bitstream 101, including source frames 105. The source video bitstream 101 may be compressed, such as for example an MPEG-4 or MPEG-2 stream. The source video bitstream 101 may instead be uncompressed.

At step 402, the processing engine 108 determines timing information 106 and/or grouping information 107 based on the received source frames 105. The determined information may be utilized to develop synchronization points or “markers” which are for chunking purposes at a downstream decoding device which receives the processed source frames in a compressed video bitstream. The information determined from the source frames 105 may include timing information 106, such as PTSs read from the headers of the source frames. Another type of information which may be determined from the source frames is grouping information 107. Grouping information 107 relates to information, other than timing information 104, which may also be utilized downstream for chunking purposes. Grouping information 107 may include, for example, an identification of the source frames 105 which occur at scene changes, or an identification of the source frames 105 which occur at repeating regular intervals based on a number of source frames 105 in each interval, or an identification of the source frames 105 which are received as intracoded source frames in the source video bitstream 101. The source frames 105, the timing information 106 and the grouping information 107 may be signaled to a processing engine 108, such as a processor, a processing module, a firmware, an ASIC, etc.

At step 403, the processing engine 108 prepares processed frames 110, including SP frames 109, based on the received source frames. The processing engine 108 may modify the source frames 105 to be processed frames, such as processed frames 110 and SP frames 109. The processed frames 110 may be equivalent to their corresponding source frames 105. In another example, the processed frames 110 may include added referencing, such as to SP frames 109 or some other indicia which indicate that the processed frames 110 are frames in a synchronized video bitstream. The SP frames 109 are also modified source frames and may be equivalent to the processed frames 110. The modifications may also include one or more changes directed to utilizing the SP frames 109 for chunking purposes. The source frames 105 may be modified so that it marks a chunk boundary which may be utilized downstream in determining video chunk files. This may be done by marking the header of the corresponding source frame, and/or changing a source frame which relies on referencing other frames (i.e., a “P-frame” or “B-frame”) by converting it to an intracoded frame (i.e., an “I-frame”). Another change which may be implemented in preparing an SP frame 109 is by converting a source frame of any picture type to an I-frame which is also encoded to prohibit decoding referencing to frames encoded before the SP frame 109, such as, for example, an IDR frame. The SP frame 109 may also be modified to enhance processes associated with the chunker and/or the decoder at a downstream decoding device. One way these modifications may enhance downstream processing is by the SP frame 109 providing information it carries downstream, such as PTSs, clock references, video buffering verification references and other information. Source frames 105 may be also be deleted or “dropped” to enhance downstream processing at a decoding device.

The SP frames 109 may be prepared utilizing the processing engine 108 based on timing information 106 and/or grouping information 107 determined from the source frames 105. The SP frames 109 may also be prepared through the processing engine 108 implementing one or more processes, including a time stamp synchronization process, an intracoded frame synchronization process, a clock reference synchronization process, and a video buffering synchronization process.

In a time stamp synchronization process of the processing engine 108, PTS information from the source frames 105 may be reproduced, or modified by a traceable adjustment, in the processed frames 110 and/or the synchronized processed frames 109. This information in the processed frames may then be utilized as a basis of synchronizing between encoders/transcoders, such as encoding system 100, encoding a synchronized compressed video by having each encoder/transcoder independently track the PTS of the source frames.

In a first intracoded frame synchronization process of the processing engine 108, intracoded frames (i.e., I-frames) are used as a basis for synchronizing. The I-frame synchronization process may match I-frames with the incoming source video bitstream. So when a frame in the source video bitstream is an I frame, that frame is transcoded as an I frame.

A second intracoded frame synchronization process determines an existing frame as a scene change and marks it, or converts it to an I-frame, or places an I-frame on scene changes where each transcoder has the exact same scene change algorithm.

In a third intracoded frame synchronization process the encoding system 100 may output a constant group of pictures (GOP) length in which there is a fixed number of frames between each SP frame I-frame.

In a clock reference synchronization process of the processing engine 108, a clock reference from the source frames 105, such as a program clock reference (PCR) value is taken from the source frame header by the processing engine 108 and may be modified and utilized as a basis for synchronization among simultaneous video streams.

In a video buffering reference synchronization process of the processing engine 108, a video buffer verifier (VBV) reference, such as a VBV value is applied to the processed frames with the maximum VBV value being associated with the SP frames 109. The VBV value signals a decoding device of a tolerance of decoding devices to manage the output from the encoding system 100, such as by indicating a maximum chunk file size.

Dropped frame synchronization may be accomplished in various ways, such as by utilizing the processing engine 108. The processing engine 108 may synchronize the dropped frames by detecting when one of the bits in the PTS of the source frames 105. Dropped frame synchronization may also be accomplished by the processing engine 108 dropping every other frame based on PTS value.

At step 404, the encoding module 111 encodes the processed frames 110, including SP frames 109, in a SCVB 104. The SCVB 104 may be, for example, a SPTS MPEG-4 stream. The SCVB 104 may share the same PCR time base, which is synchronized from the source video bitstream 101.

At step 405, the coding system 100 transmits the SCVB 104 from the interface 112.

With reference to the method 500 in FIG. 5, at step 501, the decoding system 200 receives an SCVB, such as SCVB 104, including encoded processed frames 110 and encoded SP frames 109 otherwise as described above with respect to method 400. The encoded SP frames 109 in the SCVB 104 may describe video chunk file boundaries of video chunk files of encoded processed frames 110 in the SCVB 104.

At step 502, the chunker 205 prepares a video chunk file 206 from the received SCVB 104 utilizing the encoded SP frames 109 to identify the video chunk file boundaries of the video chunk file 206.

At step 503, the decoding unit 207 decodes the encoded processed frames 110 in the prepared video chunk file 206.

Some or all of the methods and operations described above may be provided as machine readable instructions, such as a utility, a computer program, etc., stored on a computer readable storage medium (i.e., a CRM), which may be non-transitory such as hardware storage devices or other types of storage devices. For example, they may exist as program(s) comprised of program instructions in source code, object code, executable code or other formats.

An example of a CRM includes a conventional computer system RAM, ROM, EPROM, EEPROM, and magnetic or optical disks or tapes. Concrete examples of the foregoing include distribution of the programs on a CD ROM. It is therefore to be understood that any electronic device capable of executing the above-described functions may perform those functions enumerated above.

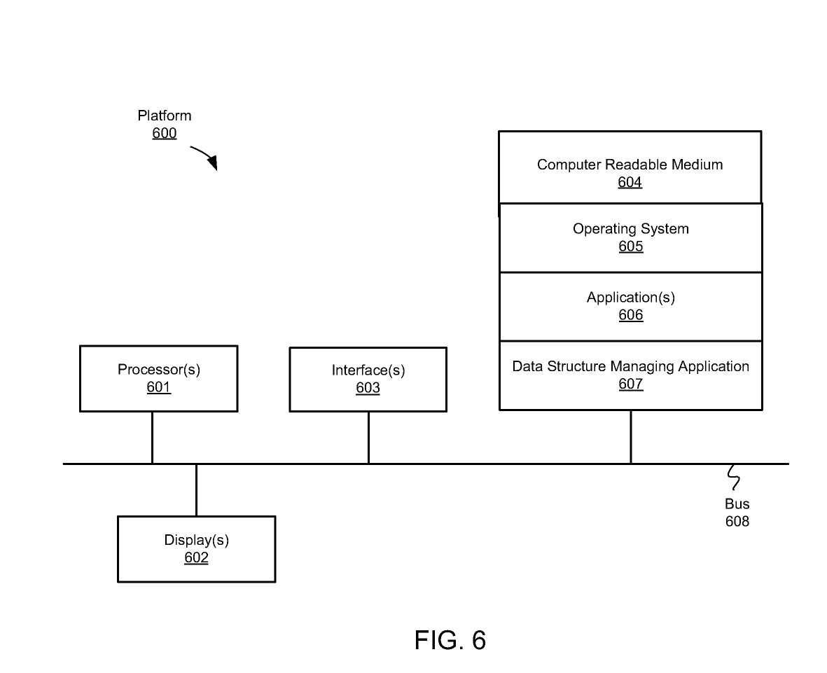

Referring to FIG. 6, there is shown a platform 600, which may be employed as a computing device in a system for coding or decoding SCVBs 104 utilizing SP frames 109, such as coding system 100 and/or decoding system 200. The platform 600 may also be used for an upstream encoding apparatus, a set top box, a handset, a mobile phone or other mobile device, a transcoder and other devices and apparatuses which may utilize perceptual representations and/or motion vectors determined utilizing the perceptual representations. It is understood that the illustration of the platform 600 is a generalized illustration and that the platform 600 may include additional components and that some of the components described may be removed and/or modified without departing from a scope of the platform 600.

The platform 600 includes processor(s) 601, such as a central processing unit; a display 602, such as a monitor; an interface 603, such as a simple input interface and/or a network interface to a Local Area Network (LAN), a wireless 802.11x LAN, a 3G or 4G mobile WAN or a WiMax WAN; and a computer-readable medium 604. Each of these components may be operatively coupled to a bus 1108. For example, the bus 1108 may be an EISA, a PCI, a USB, a FireWire, a NuBus, or a PDS.

A CRM, such as CRM 604 may be any suitable medium which participates in providing instructions to the processor(s) 601 for execution. For example, the CRM 604 may be non-volatile media, such as an optical or a magnetic disk; volatile media, such as memory; and transmission media, such as coaxial cables, copper wire, and fiber optics. Transmission media can also take the form of acoustic, light, or radio frequency waves. The CRM 604 may also store other instructions or instruction sets, including word processors, browsers, email, instant messaging, media players, and telephony code.

The CRM 604 may also store an operating system 605, such as MAC OS, MS WINDOWS, UNIX, or LINUX; applications 606, network applications, word processors, spreadsheet applications, browsers, email, instant messaging, media players such as games or mobile applications (e.g., “apps”); and a data structure managing application 607. The operating system 605 may be multi-user, multiprocessing, multitasking, multithreading, real-time and the like. The operating system 605 may also perform basic tasks such as recognizing input from the interface 603, including from input devices, such as a keyboard or a keypad; sending output to the display 602 and keeping track of files and directories on CRM 604; controlling peripheral devices, such as disk drives, printers, image capture device; and managing traffic on the bus 608. The applications 606 may include various components for establishing and maintaining network connections, such as code or instructions for implementing communication protocols including TCP/IP, HTTP, Ethernet, USB, and FireWire.

A data structure managing application, such as data structure managing application 607 provides various code components for building/updating a computer readable system (CRS) architecture, for a non-volatile memory, as described above. In certain examples, some or all of the processes performed by the data structure managing application 607 may be integrated into the operating system 605. In certain examples, the processes may be at least partially implemented in digital electronic circuitry, in computer hardware, firmware, code, instruction sets, or any combination thereof.

According to principles of the invention, there are systems, methods, and CRMs which provide for coding and decoding SCVBs. These achieve synchronization among various coding sources utilizing the SCVBs and without signaling chunk boundary information among the various coding sources as the sources associated with the systems, methods, and CRMs do not need to communicate with each other. The synchronization reduces the glitches and jitters which may otherwise occur in a displayed video which is viewed at a receiving device. The systems, methods and CRMs therefore enhance a user's experience with their mobile decoding device without a need for communicating synchronization information among sources, which may be expensive, unreliable and otherwise not possible.

Although described specifically throughout the entirety of the instant disclosure, representative examples have utility over a wide range of applications, and the above discussion is not intended and should not be construed to be limiting. The terms, descriptions and figures used herein are set forth by way of illustration only and are not meant as limitations. Those skilled in the art recognize that many variations are possible within the spirit and scope of the examples. While the examples have been described with reference to examples, those skilled in the art are able to make various modifications to the described examples without departing from the scope of the examples as described in the following claims, and their equivalents.

What is claimed is:

1. A system for coding, the system comprising:
an interface configured to
receive a source video bitstream, including source frames; and
a processor configured to
determine at least one of timing information and grouping information, based on the received source frames,
prepare processed frames, including synchronizing processed frames, based on the received source frames, wherein the synchronizing processed frames are prepared based on at least one of
the determined timing information, and
the determined grouping information, and
encode the processed frames, including the synchronizing processed frames, in a synchronized compressed video bitstream.

2. The system of claim 1, wherein the processed frames are prepared utilizing at least one process from the processes including:
a time stamp synchronization process,
an intracoded frame synchronization process,
a clock reference synchronization process, and
a video buffering synchronization process.

3. The system of claim 1, wherein at least one of the source video bitstream and the synchronized compressed video bitstream is an MPEG-4 compressed video bitstream.

4. The system of claim 1, wherein the synchronizing processed frames are intracoded.

5. The system of claim 1, wherein the synchronizing processed frames are coded to prohibit decoding referencing to frames encoded before the synchronizing processed frames.

6. The system of claim 2, wherein the processor is configured to determine the timing information by identifying time stamp values associated with respective source frames.

7. The system of claim 6, wherein the time stamp synchronization process includes
associating the identified time stamp values with processed frames which correspond with the respective source frames associated with the identified time stamp values, and
preparing synchronizing processed frames based on source frames and the identified time stamp values associated with the source frames.

8. The system of claim 6, wherein the processor is configured to prepare the processed frames based on the determined timing information including identifying droppable source frames based on a source frame dropping criterion, and
excluding the identified droppable source frames from the received source frames utilized in preparing the processed frames.

9. The system of claim 6, wherein the clock reference synchronization process includes
modifying clock reference values associated with the source frames based on a clock reference modification criterion,
associating the modified clock reference values with the processed frames, and
preparing synchronizing processed frames based on the modified clock reference values.

10. The system of claim 2, wherein the intracoded frame synchronization process includes at least one sub-process from the sub-processes including:
if the received source video bitstream is compressed, a general intracoding sub-process including
identifying the received source frames which are intracoded, and
preparing the synchronizing processed frames based on the identified intracoded source frames,
a scene change coding sub-process including
selecting scene change source frames associated with scene changes to scenes depicted by the source frames, wherein the scene change source frames are selected according to a scene change frame selection criterion, and
preparing the synchronizing processed frames based on the selected scene change source frames, and
an end group coding sub-process including
selecting end group source frames associated with the endings of fixed size frame groups within the source frames, wherein the end group source frames are selected according to an end group frame selection criterion, and
preparing the synchronizing processed frames based on the identified end group source frames.

11. The system of claim 2, wherein the video buffering synchronization process includes
modifying video buffer reference values associated with the source frames based on a video buffer reference modification criterion, and
preparing the synchronizing processed frames based on the modified video buffer reference values.

12. A method for coding, the method comprising:
receiving a source video bitstream, including source frames;
determining, utilizing a processor, at least one of timing information and grouping information, based on the received source frames;
preparing processed frames, including synchronizing processed frames, based on the received source frames, wherein the synchronizing processed frames are prepared based on at least one of
the determined timing information, and
the determined grouping information; and
encoding the processed frames, including the synchronizing processed frames, in a synchronized compressed video bitstream.

13. A non-transitory computer readable medium (CRM) storing computer readable instructions which, when executed by a computer system, perform a method for coding, the method comprising:
receiving a source video bitstream, including source frames;
determining, utilizing a processor, at least one of timing information and grouping information, based on the received source frames;
preparing processed frames, including synchronizing processed frames, based on the received source frames, wherein the synchronizing processed frames are prepared based on at least one of
the determined timing information, and
the determined grouping information; and
encoding the processed frames, including the synchronizing processed frames, in a synchronized compressed video bitstream.

14. A system for decoding, the system comprising:
an interface configured to
receive a synchronized compressed video bitstream, including encoded processed frames and encoded synchronizing processed frames,
wherein the encoded synchronizing processed frames in the synchronized compressed video bitstream describe video chunk file boundaries of video chunk files of encoded processed frames in the synchronized compressed video bitstream; and
a processor configured to
prepare a video chunk file from the received synchronized compressed video bitstream, utilizing the encoded synchronizing processed frames to identify the video chunk file boundaries of the video chunk file, and
decode the encoded processed frames in the prepared video chunk file.

15. The system of claim 14, wherein the synchronizing processed frames are based on source frames from a source video bitstream and prepared based on at least one of
timing information determined from the source frames, and
grouping information determined from the source frames, and
the synchronizing processed frames are prepared utilizing at least one process from the processes including
a time stamp synchronization process,
an intracoded frame synchronization process,
a clock reference synchronization process, and
a video buffering synchronization process.

16. The system of claim 15, wherein the time stamp synchronization process includes
associating the identified time stamp values with processed frames which correspond with respective source frames associated with the identified time stamp values, and
preparing synchronizing processed frames based on source frames and the identified time stamp values associated with the source frames.

17. The system of claim 15, wherein the clock reference synchronization process includes
modifying clock reference values associated with the source frames based on a clock reference modification criterion,
associating the modified clock reference values with the processed frames, and
preparing synchronizing processed frames based on the modified clock reference values.

18. The system of claim 15, wherein the intracoded frame synchronization process includes at least one sub-process from the sub-processes including:
if the received source video bitstream is compressed, a general intracoding sub-process including
identifying the source frames which are intracoded, and
preparing the synchronizing processed frames based on the identified intracoded source frames,
a scene change coding sub-process including
selecting scene change source frames associated with scene changes to scenes depicted by the source frames, wherein the scene change source frames are selected according to a scene change frame selection criterion, and
preparing the synchronizing processed frames based on the selected scene change source frames, and
an end group coding sub-process including
selecting end group source frames associated with the endings of fixed size groups within the source frames, wherein the end group source frames are selected according to an end group frame selection criterion, and
preparing the synchronizing processed frames based on the identified end group source frames.

19. A method for decoding, the method comprising:
receiving a synchronized compressed video bitstream, including encoded processed frames and encoded synchronizing processed frames,
wherein the encoded synchronizing processed frames in the synchronized compressed video bitstream describe video chunk file boundaries of video chunk files of encoded processed frames in the synchronized compressed video bitstream;
preparing a video chunk file from the received synchronized compressed video bitstream, utilizing the encoded synchronizing processed frames to identify the video chunk file boundaries of the video chunk file; and
decoding, utilizing a processor, the encoded processed frames in the prepared video chunk file.

20. A non-transitory computer readable medium (CRM) storing computer readable instructions which, when executed by a computer system, perform a method for decoding, the method comprising:
receiving a synchronized compressed video bitstream, including encoded processed frames and encoded synchronizing processed frames,
wherein the encoded synchronizing processed frames in the synchronized compressed video bitstream describe video chunk file boundaries of video chunk files of encoded processed frames in the synchronized compressed video bitstream;
preparing a video chunk file from the received synchronized compressed video bitstream, utilizing the encoded synchronizing processed frames to identify the video chunk file boundaries of the video chunk file; and
decoding, utilizing a processor, the encoded processed frames in the prepared video chunk file.
